(19) United States
(12) Patent Application Publication
(10) Pub. No.: US 2014/0140670 A1
(43) Pub. Date: May 22, 2014

(54) SMALL-DIAMETER HIGH BENDING-RESISTANCE FIBER OPTIC CABLE

(71) Applicant: Kuang-Bang Hsu, Taipei (TW)

(72) Inventor: Kuang-Bang Hsu, Taipei (TW)

(21) Appl. No.: 13/682,750

(22) Filed: Nov. 21, 2012

(51) Int. Cl. G02B 6/44

(52) U.S. Cl. CPC G02B 6/443
USPC 385/101; 385/113

(57) ABSTRACT

A small-diameter high bending-resistance fiber optic cable adapted for obtaining high bending-resistance and crush-resistance is provided. The small-diameter high bending-resistance and crush-resistance fiber optic cable is particularly adapted for being deployed in indoor pipelines. The small-diameter high bending-resistance and crush-resistance fiber optic cable includes at least one optical fiber core, an outer protection sheath, and a plurality of tensile strength members. The optical fiber core is positioned in a center of the outer protection sheath. The tensile strength members are uniformly distributed inside the outer protection sheath. The tensile strength members are made of aramid yarns, fiber reinforced plastics or steel wires.

The present invention is a CIP (continuation in part) of U.S. patent application Ser. No. 12/765,874 applied to USPTO on Apr. 23, 2010 and assigned to the inventor of the present invention. Therefore, the contents of the U.S. Ser. No. 12/765,874 is incorporated into the present invention as a part of the present invention.

### BACKGROUND OF THE INVENTION

1. Field of the Invention

The present invention relates generally to a small-diameter high crush-resistance and bending-resistance fiber optic cable. The fiber optic cable includes an outer protection sheath including a tensile strength member for improving tensile strength and bending resistance of the fiber optic cable and thus it is particularly adaptable for indoor/outdoor cable routing.

2. The Prior Arts

In fiber-to-the-home (FTTH) optical communication network, the fiber optic cables used for accessing the clients or deployed in the inner ducts of the buildings are often soft flexible cables with a lower bending-resistance and crush resistance.

Referring to FIG. 1, a cross-sectional view of a conventional soft flexible fiber optic cable is illustrated. As shown in FIG. 1, the soft flexible fiber optic cable includes a single-core fiber 1 and an outer protection sheath 2. The outer protection sheath 2 axially covers along an axial periphery of the single-core fiber 1 so as to enclose the fiber 1 for protecting the single-core fiber 1. Typically, the single-core fiber 1 is often further enclosed by a protected UV-curable resin layer. The outer protection sheath 2 is covered on the single-core Fiber 1, thus configuring a cable structure. Further, although only one single-core fiber 1 is shown for exemplification in FIG. 1, in some other circumstances, multiple single-core fibers can be parallel arranged or stranded as a whole and then be covered by the outer protection sheath 2.)

Referring to FIG. 2, a cross-section of another conventional soft flexible fiber optic cable is illustrated. As shown in FIG. 2, the soft flexible fiber optic cable includes coloring optical fiber (or ribbon fiber or tight buffer fiber 10 and an outer protection sheath 20. The outer protection sheath 20 is made of a plastic material such as polyvinyl chloride (PVC), polyethylene (PE), or low smoke zero halogen (LSZH). The soft flexible fiber optic cable, as shown in FIG. 2, may also includes a strengthening layer 30 disposed between the optical fiber 10 and the outer protection sheath 20. The strengthening layer 30 is an aramid yarns which are soft and strong, and adapted for strengthening the structure of the soft flexible fiber optic cable.

Even when the conventional soft flexible fiber optic cable has a strengthening layer for strengthening the structure of the fiber optic cable, the rigidity of the aramid yarn material is still less than enough, so that the bending-resistance and crush-resistance of the conventional soft flexible fiber optic cables are not satisfactory. When such a conventional soft flexible fiber optic cable is tightly tensioned and deployed in an indoor environment which may require the fiber optic cable to be bent and side crush frequently, the optical fiber contained therein is often likely to be damaged or even broken. Therefore, when the engineering staff tests the communication quality, they may have to spend a lot of time on checking broken places. In such a way, the maintenance cost is very high. Accordingly, a small-diameter high bending-resistance and crush-resistance fiber optic cable is desired.

### SUMMARY OF THE INVENTION

A primary objective of the present invention is to provide a small-diameter high bending-resistance and crush resistance fiber optic cable. Specifically, the present invention is adapted for improving the crush-resistance and bending-resistance of a small-diameter fiber optic cable, so as to provide an optimal protection to optical fibers contained therein for information transmission. As such, the present invention is also adapted for allowing the engineering staff to deploy the small-diameter fiber optic cable in crowded inner ducts in the indoor environment, and reducing the possibility of breaking or bending the optical fibers.

For achieving the foregoing objective, the present invention provides a small-diameter high bending-resistance and crush-resistance fiber optic cable for obtaining high bending-resistance and crush-resistance. The small-diameter high bending-resistance and crush-resistance fiber optic cable is particularly adapted for being deployed in indoor pipelines. The small-diameter high bending-resistance and crush-resistance fiber optic cable includes at least one optical fiber, an outer protection sheath, and a plurality of tensile strength members. The optical fiber is positioned in a center of the outer protection sheath. The tensile strength members are uniformly distributed inside the outer protection sheath. The tensile strength members are made of reinforce aramid yarns or fiber reinforce plastic material.

According to an embodiment of the present invention, the small-diameter high bending-resistance and crush-resistance fiber optic cable further includes a sheath strengthening member adapted for fixing the small-diameter high bending-resistance and crush-resistance fiber optic cable can be fixed by fixing the sheath strengthening member without fixing the optical transmission unit (e.g., the optical fibers) Therefore, when the small-diameter high bending-resistance and crush-resistance fiber optic cable is fixed, the optical transmission unit is avoided from suffering mechanical impact. Alternatively, the sheath strengthening member having very strong mechanical strength instead of the optical transmission unit is fixed. Accordingly, the small-diameter high bending-resistance and crush-resistance fiber optic cable can be conveniently deployed in many different sites.

According to another embodiment of the present invention, the small-diameter high bending-resistance fiber optic cable includes a hollow tube cable structure and an optical transmission unit extending there through. In such a way, the present invention provides a small-diameter high bending-resistance and crush-resistance fiber optic cable. A small-diameter high bending-resistance and crush-resistance fiber optic cable can be obtained immediately before it is to be deployed by assembling an optical fiber inside the small-diameter high bending-resistance and crush-resistance fiber optic cable. Accordingly, the present invention is adapted for avoiding the installation and assembly risk and assuring the quality of the optical fiber.

Generally, the present invention provides a solution to the difficulties of the conventional technologies, and drastically improves the overall bending-resistance and crush-resistance of the small-diameter fiber optic cable, so as to allow the engineering staff to conveniently deploy the fiber optic cables in the indoor/outdoor environment.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a cross-sectional view of a conventional flexible fiber optic cable;

FIG. 2 is a cross-sectional view of another conventional flexible fiber optic cable;

FIG. 3 is a cross-sectional view of a small-diameter high bending-resistance fiber optic cable according to a first embodiment of the present invention;

FIG. 4 is a cross-sectional view of a small-diameter high bending-resistance and crush-resistance fiber optic cable according to a second embodiment of the present invention;

FIG. 5 is a cross-sectional view of a small-diameter high bending-resistance and crush-resistance fiber optic cable according to a third embodiment of the present invention;

FIG. 6 is a cross-sectional view of a small diameter high bending-resistance and crush-resistance fiber optic cable according to a fourth embodiment of the present invention;

FIG. 7 is a cross-sectional view of a small-diameter high bending-resistance and crush-resistance fiber optic cable according to a fifth embodiment of the present invention; and

FIG. 8 is a cross-sectional view of a small-diameter high bending-resistance and crush-resistance fiber optic cable according to a sixth embodiment of the present invention;

FIG. 9 is a cross sectional view showing that aramid yarns are disposed inside the optical fiber communication unit.

FIG. 10 is a cross sectional view showing that the optical fibers within the optical fiber communication unit are bundled as a bundle of fiber within a plastic enclosure.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and together with the description, serves to explain the principles of the invention.

FTTH is signal transmission approach of optical fiber communication which is often adopted by telecommunication service providers. According to the FTTH approach, optical fiber reaches the boundary of the living space, such as a communication box on the outside wall of a house. In other words, it is also known as “last mile” construction of the optical fiber communication network to the client ends. The present invention provides a small-diameter high bending-resistance and crush-resistance fiber optic cable specifically adapted for the “last mile” construction to the communication box of the user's building.

FIG. 3 is a cross-sectional view of a small-diameter high bending-resistance and crush-resistance fiber optic cable according to a first embodiment of the present invention. Referring to FIG. 3, a small-diameter high bending-resistance and crush-resistance fiber optic cable is illustrated. The small-diameter high bending-resistance and crush-resistance fiber optic cable has a diameter at least smaller than 6 mm. The small-diameter high bending-resistance and crush-resistance fiber optic cable includes an optical fiber communication unit 100, an outer protection sheath 200 and a plurality of tensile-resistance members 300. The optical fiber communication unit 100 is a medium adapted for transmitting optical signals.

The optical fiber communication unit 100 includes at least one optical fiber. The optical fiber for example is a coloring fiber, a ribbon fiber, a tight buffer fiber or any other suitable optical fibers. The outer protection sheath 200 is disposed over the optical fiber communication unit 100. Relatively, the optical fiber communication unit 100 is positioned at a center or other position of the outer protection sheath 200. The outer protection sheath 200 is configured as a hollow tube cable member having a cross-section of a round shape, an elliptical shape, or other suitable shapes. Such a specific shape of the outer protection sheath 200 is particularly adapted for providing an improved protection to the optical fiber communication unit 100. It is known that when a square shaped hollow tube cable or the like is applied with an external force, the pressures conveyed from different position to the optical fiber are inconsistent, and therefore the optical fiber is more likely to be broken. On the contrary, the round shaped or elliptical shaped outer protection sheath 200 conveys uniformly distributed pressure to the optical fiber, thus providing an overall protection thereto.

Each of the tensile strength members 300 is configured as a pipe member extending inside the outer protection sheath 200 along and in parallel with the optical fiber communication unit 100. Each of the tensile strength members 300 has a cross-section of a round shape, an elliptical shape or other suitable shapes. As shown in FIG. 3, the small-diameter high bending-resistance and crush-resistance fiber optic cable includes two tensile strength members 300. However, it should be noted that the quantity of, the tensile strength members 300 employed inside the small-diameter high bending-resistance and crush-resistance fiber optic cable can be practically modified and is not restricted by the present invention.

Preferably, the tensile strength members 300 are made of a fiber reinforced plastic (FRP) or reinforced aramid yarn material. Specifically, the FRP material is selected from the group consisting of glass fiber reinforced plastic (GFRP), carbon fiber reinforced plastic (CFRP), and Kevlar fiber reinforced plastic (K-FRP). Alternatively, the tensile strength members 300 can also be steel wires.

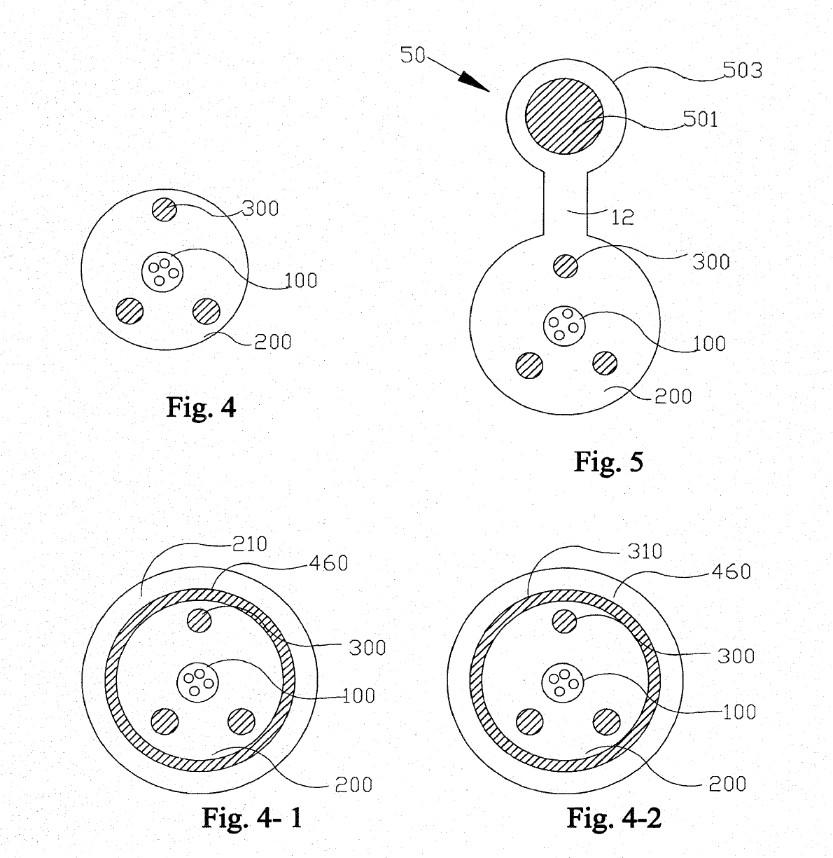

FIG. 4 is a cross-sectional view of a small-diameter high bending-resistance and crush-resistance fiber optic cable according to a second embodiment of the present invention. Referring to FIG. 4, a small-diameter high bending-resistance and crush-resistance fiber optic cable is illustrated. The small-diameter high bending-resistance and crush-resistance fiber optic cable includes an optical fiber communication unit 100 and three tensile strength members 300. The optical fiber communication unit 100 includes multiple optical fibers. Referring to FIGS. 3 and 4 together, it can be learnt that the quantity of the optical fibers of the optical communication unit 100, the quantity of the tensile strength members 300, and the distribution thereof can be adaptively modified for satisfying practical requirements. The outer protection sheath 200 together with the associated tensile strength members 300 can effectively improve the bending resistance and crushing resistance of the fiber optic cable during the deploying operation.

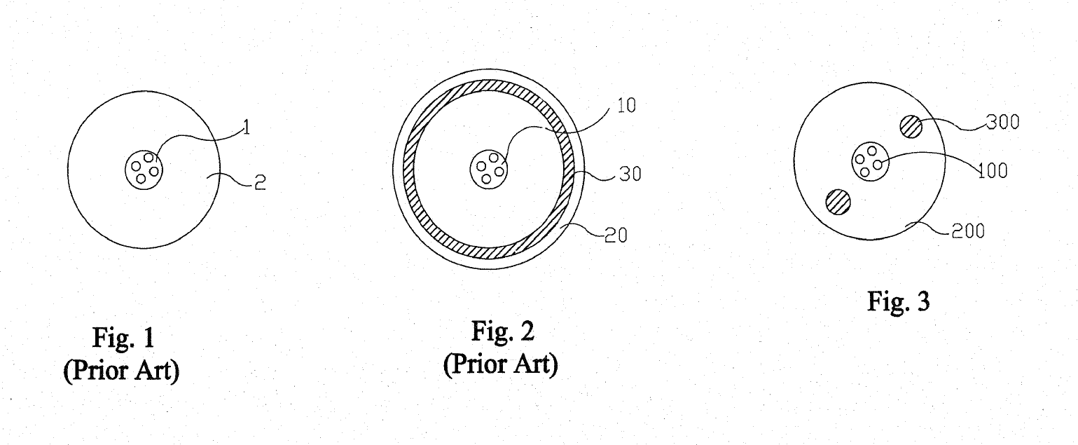

With reference to FIG. 4-1, a further form about this second embodiment according to the present invention is shown, in that, a multiple copper wire layer 460 further encloses the outer protection sheath 200 therein and then another protection sheath 210 further encloses the copper wire layer 460. The function of the copper wire layer 460 is formed as a hybrid copper-optical fiber cable to be as an electric signal transmission line or an electric power line and thus this form provides a firm structure to the small-diameter high bending-resistance and crush-resistance hybrid copper-fiber optic cable.

Furthermore, FIG. 4-2 shows another application about this embodiment, in that, a tensile strength layer 310 encircles the outer protection sheath 200 and then another protection sheath 210 further encloses the tensile strength layer 310 therein so as to provide a concrete structure to the fiber optic cable of the present invention.

FIG. 5 is a cross-sectional view of a small-diameter high bending-resistance and crush-resistance fiber optic cable according to a third embodiment of the present invention. Comparing with the first and the second embodiments, the small-diameter high bending-resistance and crush-resistance fiber optic cable shown in FIG. 5 further includes a sheath supporting member 50, and a connection portion 12 connecting the optical communication unit 100 and the sheath supporting member 50. The optical communication unit 100 and the sheath supporting member 50 are parallel disposed. The outer layer of the sheath supporting member 50 is a supporting member 501 and the inner layer of the sheath supporting member 50 is a protection member 503. The supporting member 501 is adapted for improving a structural strength of the sheath supporting member 50. The supporting member 501 for example is made of a GFRP, a steel wire, or other suitable materials. The sheath supporting member 50 is provided for achieving the convenience of fixing the fiber optic cable. The fiber optic can be fixed by fixing the protection member 503 of the sheath supporting member 50, or fixing the protection member 503 of the sheath supporting member 50 together with the connection portion 12. In such a way, when the small-diameter high bending-resistance and crush-resistance fiber optic cable is fixed, the optical transmission unit 100 is avoided from suffering mechanical impact. Alternatively, the sheath supporting member 50 having very strong mechanical strength instead of the optical transmission unit 100 is fixed. Accordingly, the small-diameter high bending-resistance and crush-resistance fiber optic cable can be conveniently deployed in many different sites.

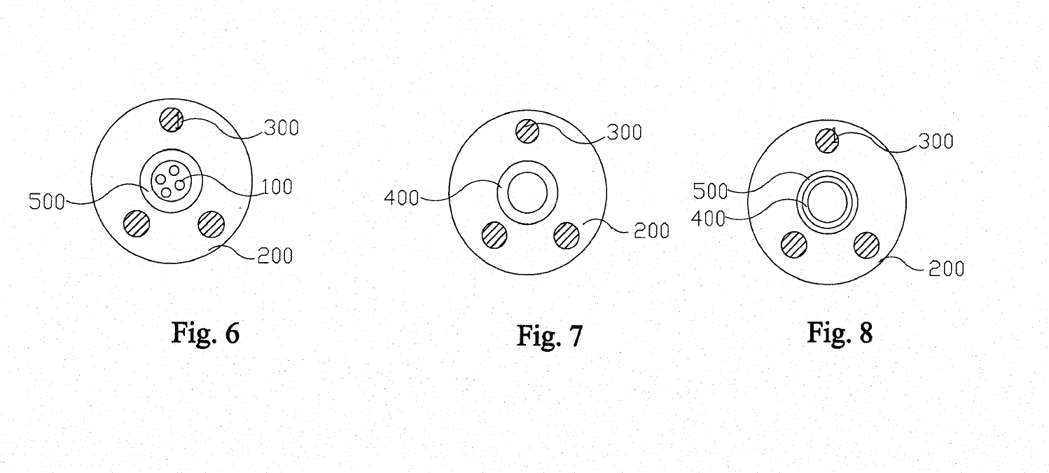

FIG. 6 is a cross-sectional view of a small-diameter high bending-resistance and crush-resistance fiber optic cable according to a fourth embodiment of the present invention. According to the third embodiment of the present invention, and comparing with the second embodiment as shown in FIG. 4, the small-diameter high bending-resistance and crush-resistance fiber optic cable further includes an aramid yarn layer 500 disposed between the optical fiber communication unit 100 and the outer protection sheath 200. The aramid yarn layer 500 is parallel to the outer surface of the optical fiber communication unit 100. The aramid yarns are adapted for improving a structural strength of the small-diameter high bending-resistance and crush-resistance fiber optic cable.

FIG. 7 is a cross-sectional view of a small-diameter high bending-resistance and crush-resistance fiber optic cable according to a fifth embodiment of the present invention. Referring to FIG. 7, the small-diameter high bending-resistance and crush-resistance fiber optic cable includes a hollow tube cable structure 400, an outer protection sheath 200, and a plurality of tensile strength members 300. The small-diameter high bending-resistance and crush-resistance fiber optic cable has an outer diameter smaller than 6 mm. The outer protection sheath 200 axially covers along a periphery of the hollow tube cable structure 400. The tensile strength members 300 are disposed inside and extending along the outer protection sheath 200. Preferably, the tensile strength members 300 are made of an FRP or K-FRP material. Specifically, the FRP material is selected from the group consisting of GFRP, K-FRP, and steel wire. The hollow tube cable structure 400 is adapted for being provided with an optical transmission unit 100 extending there through. In such a way, the present invention provides a small-diameter high bending-resistance and crush-resistance fiber optic cable. A small-diameter high bending-resistance and crush-resistance fiber optic cable can be obtained immediately before it is to be deployed by assembling an optical fiber inserting the small-diameter high bending-resistance and crush-resistance fiber optic cable. The optical fiber for example is a coloring fiber, a ribbon fiber, a tight buffer fiber, or any other suitable optical fibers. Accordingly, the present invention is adapted for reducing the high fiber count cable diameter and sustain the high mechanical ability in order to assuring the quality of the optical fiber.

The hollow tube cable structure 400 is made of thermoplastic material. And more preferably a thermoplastic polyester elastomer having an optimal tenacity, deformation-resistance, and deflection-resistance.

FIG. 8 is a cross-sectional view of a small-diameter high bending-resistance and crush-resistance fiber optic cable according to a sixth embodiment of the present invention. Comparing with the fifth embodiment of the present invention, the small-diameter high bending-resistance and crush-resistance fiber optic cable further includes an aramid yarn layer 500 disposed between the hollow tube cable structure 400 and the outer protection sheath 200. The aramid yarn layer 500 circularly covers an outer surface of the hollow tube cable structure 400. The aramid yarn layer 500 is constituted of a plurality of aramid yarns, and is adapted for improving a structural strength of the small-diameter high bending-resistance and crush-resistance fiber optic cable. When the fiber optic cable endures a tensile force, the aramid yarn layer 500 generates a counter force against the tensile force, such that the optical fiber communication unit 100 can be protected thereby.

It should be noted that although not specifically disclosed in every embodiment of the present invention, the sheath strengthening member 50 as discussed in the third embodiment of FIG. 5 can be used in conjunction with any embodiment of the present invention, in which the sheath strengthening member 50 is required to be arranged in parallel with the hollow tube cable structure 400 or the optical fiber communication unit 100.

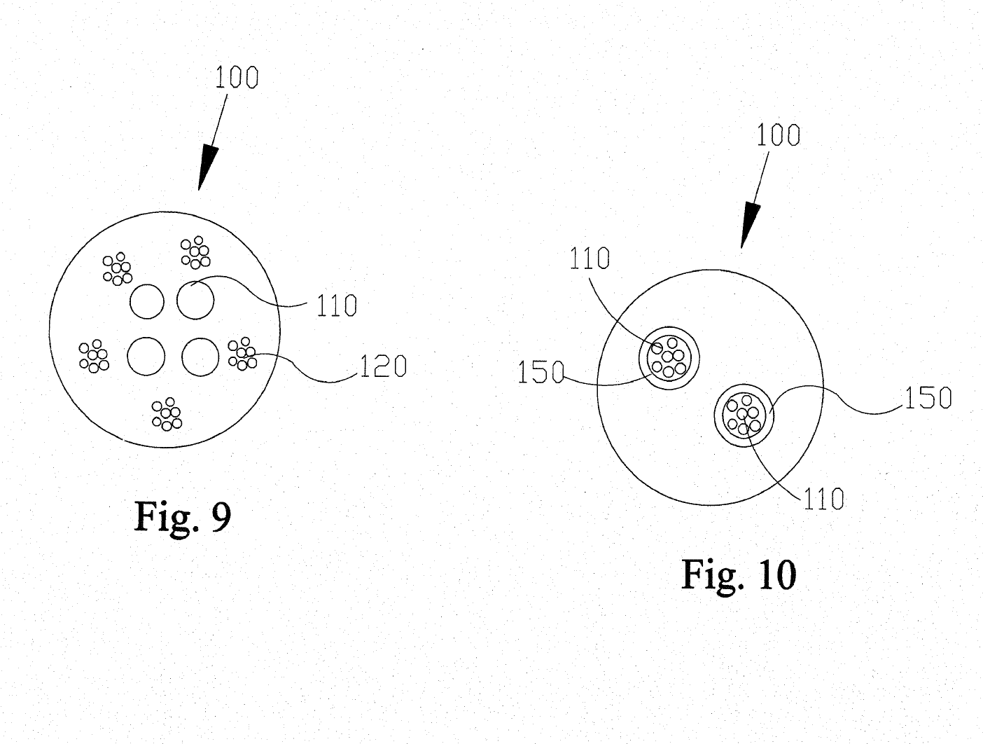

However in all above mentioned cases, as illustrated in FIG. 9, other than optical fibers 110, aramid yarns 120 can be disposed inside the optical fiber communication unit 100 so as to intensify the axial strength of the optical fibers. Preferably, a plurality of aramid yarns are combined as a bundle for simplifying the arrangement of the aramid yarns within the optical fiber communication unit 100. It should be noted that the structure of FIG. 9 only shows the optical fiber communication unit 100, however the optical fiber communication unit 100 shown in FIG. 9 can be matched with any other outer protection sheath 200 with any kind of tensile strength structure or copper wire structure (see FIG. 4-1). All these structures are within the scope of the present invention.

Further referring to FIG. 10, in this embodiment, the optical fibers within the optical fiber communication unit 100 can be bundled as a bundle of fiber within a plastic enclosure 150 so as to enhance the structural strength of the fiber. Similarly, it should be noted that the structure of FIG. 10 only shows the optical fiber communication unit 100, however the optical fiber communication unit 100 shown in FIG. 10 can be matched with any other outer protection sheath 200 with any kind of tensile strength structure or copper wire structure (see FIG. 4-1). All these structures are within the scope of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A small-diameter high bending-resistance and crush-resistance fiber optic cable, comprising;
an optical fiber communication unit comprising at least one optical fiber;
an outer protection sheath axially enclosing the optical fiber communication unit, wherein the optical fiber communication unit is positioned at approximately axially central portion of the outer protection sheath; and
at least three tensile strength members uniformly distributed around the optical fiber communication unit and inside the outer protection sheath.

2. The small-diameter high bending-resistance and crush-resistance fiber optic cable as claimed in claim 1, wherein the optical fiber communication unit comprises a plurality of optical fibers.

3. The small-diameter high bending-resistance and crush-resistance fiber optic cable as claimed in claim 2, wherein the optical fibers are coloring fibers, ribbon fibers, or tight buffer fibers.

4. The small-diameter high bending-resistance and crush-resistance fiber optic cable as claimed in claim 1, wherein a radial diameter of the small-diameter high bending-resistance and crush-resistance fiber optic cable is smaller than 6 mm.

5. The small-diameter high bending-resistance and crush-resistance fiber optic cable as claimed in claim 1, wherein the tensile strength members are made of glass fiber reinforced plastic (GFRP), carbon fiber reinforced plastics (CFRP), Kevlar fiber reinforced plastic (K-FRP), reinforced aramid yarns or steel wires.

6. The small-diameter high bending-resistance and crush-resistance fiber optic cable as claimed in claim 1, further comprising:
a sheath supporting member comprising an inner layer severing as a supporting member and an outer layer serving as a protection member,
wherein the inner layer is made of a glass fiber reinforced plastic (GFRP) or a steel wire; and a connection portion connecting between the sheath supporting member and the outer protection sheath, wherein the sheath supporting member is arranged parallel extending along with optical fiber communication unit, and the outer protection sheath.

7. The small-diameter high bending-resistance and crush-resistance fiber optic cable as claimed in claim 1, further comprising an aramid yarns or glass yarns layer axially covered over the optical fiber communication unit and positioned between the optical fiber communication unit and the outer protection sheath.

8. The small-diameter high bending-resistance and crush-resistance fiber optic cable as claimed in claim 1, further comprising one more cable structure of aramid yarns which are disposed within the optical fiber communication unit.

9. The small-diameter high bending-resistance and crush-resistance fiber optic cable as claimed in claim 1, further comprising optical fibers within the optical fiber communication unit are bundled as a bundle of fiber within a plastic enclosure so as to increase the fiber count with multiple bundled fibers within optical fiber communication unit.

10. A small-diameter high bending-resistance and crush-resistance fiber optic cable, comprising
a hollow tube cable structure having a hollow space;
an outer protection sheath axially enclosing the hollow tube cable structure; and a plurality of tensile strength members uniformly distributed around the hollow tube cable structure in the outer protection sheath.

11. The small-diameter high bending-resistance and crush-resistance fiber optic cable as claimed in claim 8 wherein an optical fiber communication unit and/or a metal conducing wire is provided within the hollow space.

12. The small-diameter high bending-resistance and crush-resistance fiber optic cable as claimed in claim 9, wherein the optical fiber communication unit comprises a plurality of optical fibers.

13. The small-diameter high bending-resistance and crush-resistance fiber optic cable as claimed in claim 10, wherein the optical fibers are coloring fibers, ribbon fibers, or tight buffer fibers.

14. The small-diameter high bending-resistance and crush-resistance fiber optic cable as claimed in claim 8, wherein a radial diameter of the small-diameter high bending-resistance and crush-resistance fiber optic cable is smaller than 6 mm.

15. The small-diameter high bending-resistance and crush-resistance fiber optic cable as claimed in claim 8, wherein the hollow tube cable structure is made of a thermoplastic material.

16. The small-diameter high bending-resistance and crush-resistance fiber optic cable as claimed in claim 8, wherein the tensile strength members are made of glass fiber reinforced plastics (GFRP), carbon fiber reinforced plastics (CFRP), Kevlar reinforced plastics (K-FRP), or steel wires.

17. The small-diameter high bending-resistance fiber optic cable as claimed in claim 8, further comprising:
a sheath supporting member comprising an inner layer severing as a supporting member and an outer layer serving as a protection member, wherein the inner layer is made of a glass fiber reinforced plastic (GFRP) or a steel wire: and
a connection portion connecting between the sheath supporting member and the outer protection sheath, wherein the sheath supporting member is disposed in parallel with the hollow tube cable structure,
wherein the small-diameter high bending-resistance and crush-resistance fiber optic cable is adapted for being fixed by fixing the sheath supporting member.

18. The small-diameter high bending-resistance and crush-resistance fiber optic cable as claimed in claim 8, further comprising an aramid yarn layer axially covered over the optical fiber communication unit and positioned between the optical fiber communication unit and the outer protection sheath.

19. The small-diameter high bending-resistance and crush-resistance fiber optic cable as claimed in claim 9, further comprising one more cable structure of aramid yarns which are disposed within the optical fiber communication unit.

20. The small-diameter high bending-resistance and crush-resistance fiber optic cable as claimed in claim 9, further comprising optical fibers within the optical fiber communication unit are bundled as a bundle of fiber within a plastic enclosure so as to increase the fiber count with multiple bundled fibers within optical fiber communication unit.
